(19) United States
(12) Patent Application Publication
(10) Pub. No.: US 2025/0391405 A1
(43) Pub. Date: Dec. 25, 2025

(54) System and method to evaluate audio data

(71) Applicant: Bank of America Corporation, Charlotte, NC (US)

(72) Inventors: David Randall, Charlotte, NC (US); Emmanuel Dibia, Dallas, TX (US); Emad Noorizadeh, Plano, TX (US); Rajan Jhaveri, Prosper, TX (US); Christopher Steven Welles, Charlotte, NC (US); Sushil Golani, Waxhaw, NC (US); Ion Gerald McCusker, Allen, TX (US); John Roderick Spaugh, Matthews, NC (US); Dana P Morrow Branch, Celina, TX (US); Justin R Gonzalez, Huntersville, NC (US); Jennifer Joy Russell, Dallas, TX (US); Donatus E Asumu, Dallas, TX (US)

(21) Appl. No.: 18/749,510

(22) Filed: Jun. 20, 2024

(51) Int. Cl. G10L 15/22; G10L 15/26

(52) U.S. Cl. CPC G10L 15/22; G10L 15/26

(57) ABSTRACT

A system comprises a memory communicatively coupled to at least one processor. The memory is operable to store a machine learning algorithm configured to evaluate data in accordance with one or more machine learning models. The at least one processor is configured to obtain audio data from a user device. In response to receiving the audio data, the processor is configured to execute the machine learning algorithm to transcribe the audio data into text data and summarize the text data into a request summary. Further, the processor is configured to determine a target operation based on the request summary in response to summarizing the text data. The target operation is a determined intent to perform a communication operation. The processor is configured to map the target operation to a suggestion and presenting the suggestion to a workspace device.

### TECHNICAL FIELD

The present disclosure relates generally to sound analysis, and more specifically to a system and method to evaluate audio data.

### BACKGROUND

In communication systems, multiple devices may perform communication operations with one another. In certain communication systems, the communication operations may be data exchanges performed between two or more devices. The communication operations may consume (e.g., use) network resources each time data is exchanged. The network resources may comprise power resources, memory resources, and/or processing resources. Several network resources may be consumed in processes comprising lengthier communication operations lasting multiple minutes. Further, several resources may be consumed in processes comprising larger data exchanges in which multiple information packets are exchanged.

### SUMMARY OF THE DISCLOSURE

In one or more embodiments, systems and methods are configured to evaluate audio data. In particular, the systems are configured to dynamically generate action item suggestions based on audio data exchanged between a user device and a workspace device. The user device and the workspace device may be configured to exchange data while performing one or more communication operations. The systems may be configured to provide the action item suggestions to the workspace device based on information obtained in one or more of the communication operations. As action item suggestions are presented to the workspace device, the workspace device may be configured to perform the one or more action item suggestions. In some embodiments, the systems may be configured to identify communication operations performed between two or more devices in a communication network. The communication operations may comprise one or more data exchanges between the two or more devices. In some embodiments, the data exchanged may be audio data. Herein, the systems may be configured to execute one or more machine learning algorithms to obtain the audio data exchanged and perform one or more transcriptions on the audio data. As part of the transcription operations, the systems may be configured to generate image data and/or text data based at least in part upon the audio data. After the audio data is transcribed, the image data and/or the text data may be dynamically summarized to obtain a predicted purpose of the communication operations. At this stage, the systems are configured to determine one or more target operations based on the predicted purpose determined of the communication operations. The one or more target operations may be one or more intents supporting operations to be performed in the communication network. The systems may be configured to generate one or more suggestions comprising action items to perform, start, trigger, and/or complete the target operations. In some embodiments, the systems are configured to present the suggestions to a workspace device.

In one or more embodiments, the systems and methods described herein are integrated into a practical application of dynamically determining intent behind information shared in communication operations. In one or more embodiments, the information shared may be processed as audio data exchanged between two or more devices in real time. In this regard, real time may refer to smaller delays (e.g., milliseconds, nanoseconds, and the like) between processing time after the audio data is obtained. The audio data may be transcribed into text data and/or image data. Herein, a machine learning algorithm may be configured to structure the transcribed data in accordance with one or more machine learning models, determine motivation from the structured version of the transcribed data, and generate one or more intents (e.g., target operations) based at least in part upon the structured version of the transcribed data. In some embodiments, the systems and methods are integrated into a practical application of actively determining one or more action item suggestions based on the identified intent behind the communication operations. The action item suggestions may be proposed operations to be performed at a workspace device. In embodiments in which the communication operations comprise conversations exchanged between a user device and a workspace device, by dynamically providing action item suggestions to the workspace device, the workspace device is configured to effectively perform one or more suggested action items as soon as intent is determined in a conversation.

In one or more embodiments, the systems and methods are directed to improvements in computer systems. Specifically, the systems and methods reduce processor and memory usage in a server by reducing network resources consumed during communication operations. The communication operations may consume (e.g., use) network resources each time data is exchanged. The network resources may comprise power resources, memory resources, and/or processing resources. Herein, the systems and methods reduce consumption of network resources because communication operations are made more efficient. As intent behind the communication operations is determined in real time, action item suggestions may be determined and performed to conclude communication operations. After an action item suggestion is generated, the workspace device may be configured to suggest the action item as a targeted operation to the user device that may trigger a conclusion of the communication operations.

In one or more embodiments, the systems may comprise an apparatus, such as the server. Further, the system may be a data exchange system, that comprises the apparatus. In addition, the system may be configured to perform operations as part of a process performed by the apparatus. As a non-limiting example, the system may comprise a memory and at least one processor communicatively coupled to one another. The memory may be operable to store a machine learning algorithm configured to evaluate data in accordance with one or more machine learning models. The at least one processor may be configured to obtain audio data from a user device. In response to receiving the audio data, the processor may be configured to execute the machine learning algorithm to transcribe the audio data into text data and summarize the text data into a request summary. Further, the processor may be configured to determine a target operation based on the request summary in response to summarizing the text data. The target operation may be a determined intent to perform a communication operation. The processor may be configured to map the target operation to a suggestion and presenting the suggestion to a workspace device.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a system in accordance with one or more embodiments;

FIG. 2 illustrates an operational flow to evaluate audio data in accordance with one or more embodiments;

FIG. 3 illustrates an example flowchart of a method to perform the operational flow of FIG. 2 in accordance with one or more embodiments;

FIGS. 4A-4G illustrate example operational flows to generate information requests based on audio data in accordance with one or more embodiments; and

FIG. 5 illustrates an example flowchart of a method to perform one or more of the operational flows of FIGS. 4A-4G in accordance with one or more embodiments.

### DETAILED DESCRIPTION

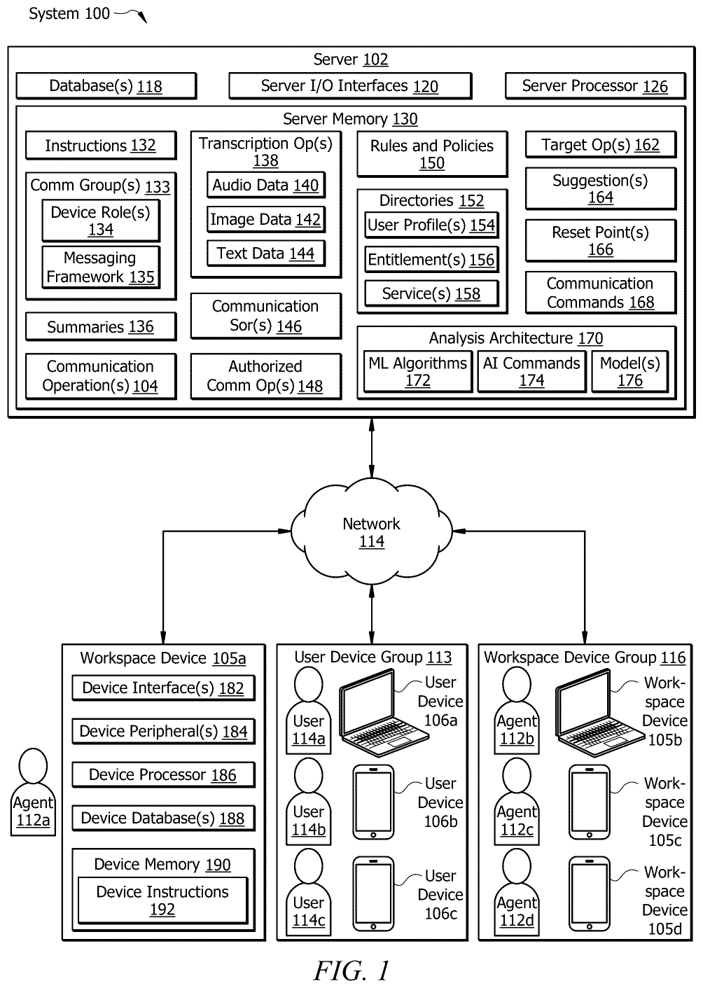

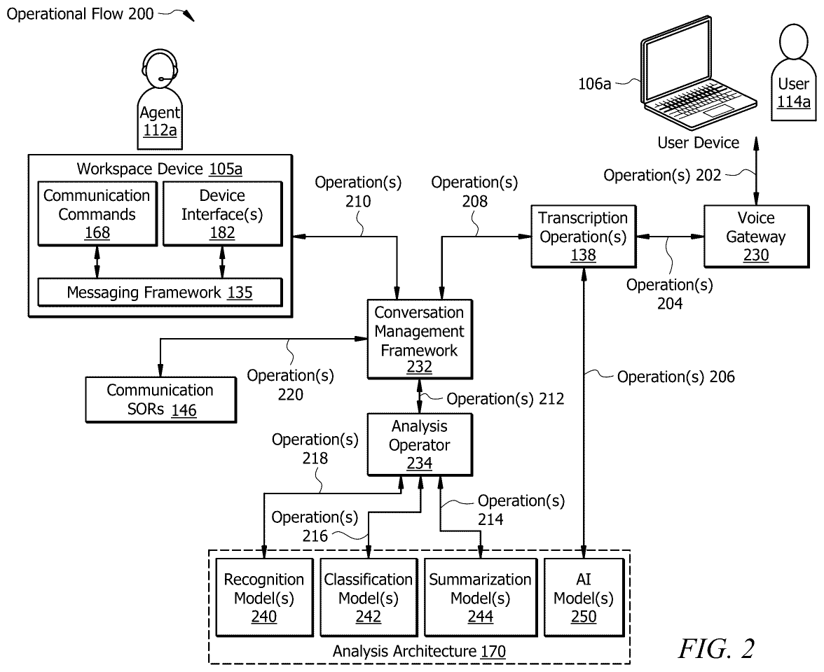

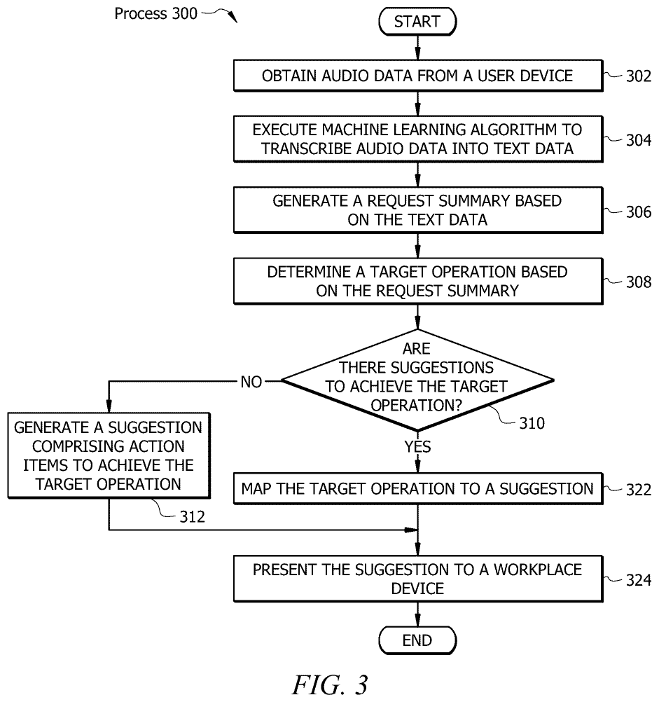

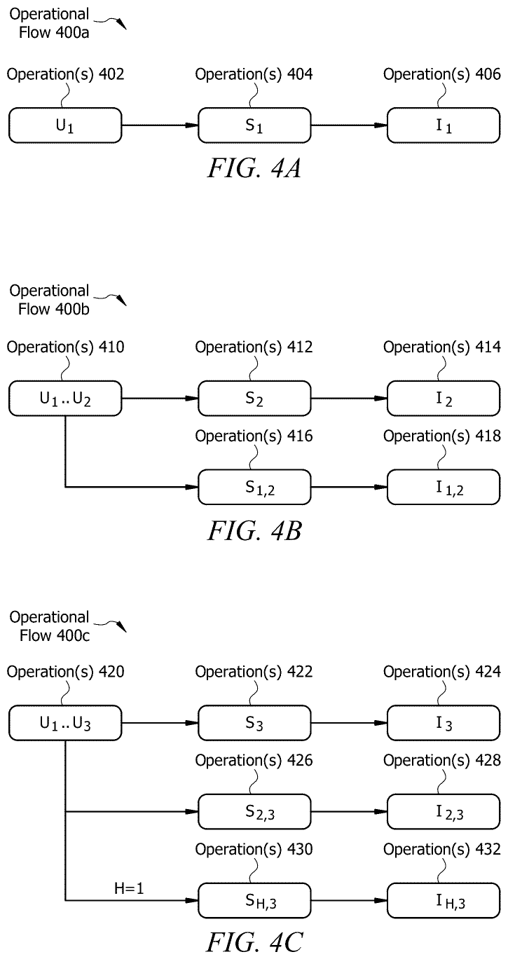

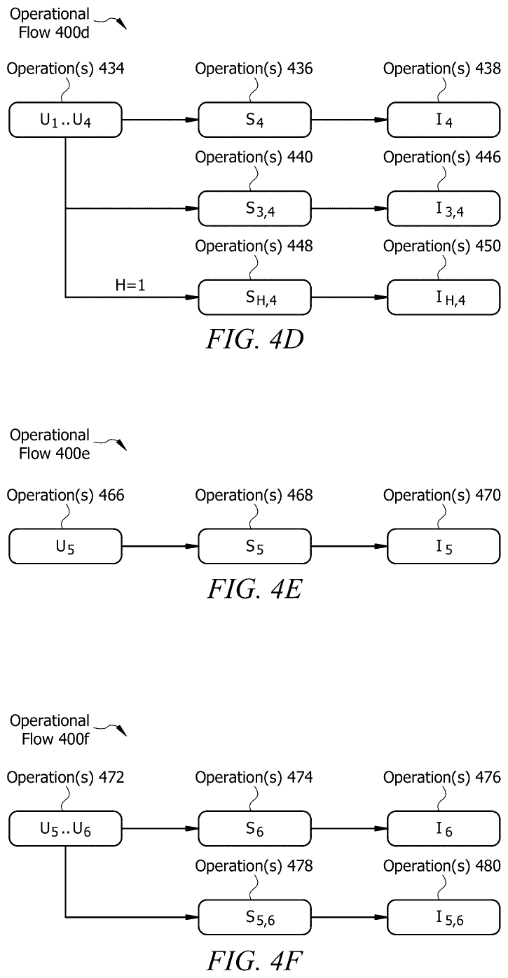

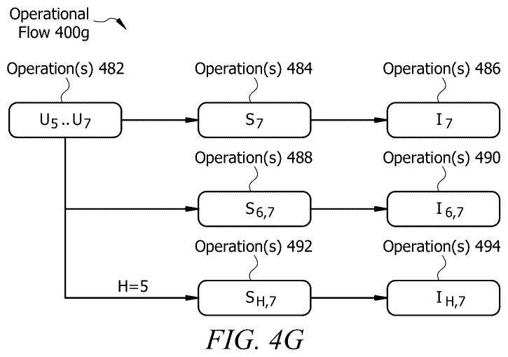

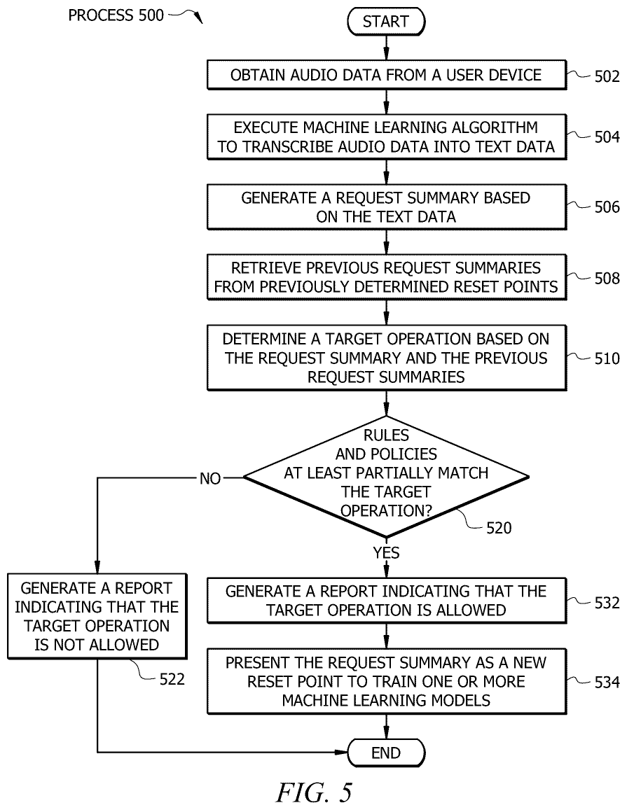

As described above, this disclosure provides various systems and methods to evaluate audio data. Further, this disclosure provides various systems and methods to generate information requests based on audio data. FIG. 1 illustrates a system 100 in which a server 102 evaluates one or more communication operations 104. FIG. 2 illustrates an operation flow 200 performed by the system 100 of FIG. 1. FIG. 3 illustrates a process 300 performed by the system 100 of FIG. 1. FIGS. 4A-4G illustrate operational flows 400a-400g performed by the system 100 of FIG. 1. FIG. 5 illustrates a process 500 performed by the system 100 of FIG. 1.

### System Overview

FIG. 1 illustrates a system 100 configured to evaluate one or more communication operations 104. In the system 100 of FIG. 1, a server 102 is communicatively coupled to multiple workspace devices 105a-105d (collectively, workspace devices 105) and multiple user devices 106a-106c (collectively, user devices 106) via a network 110. In some embodiments, the workspace device 105a is a standalone device, while the workspace device 105b, the workspace device 105c, and the workspace device 105d may be incorporated in a workspace device group 111. Each of the workspace device 105a, the workspace device 105b, the workspace device 105c, and the workspace device 105d may be operated by an agent 112a, an agent 112b, an agent 112c, and an agent 112d, respectively. The workspace device group 111 may comprise less or more workspace devices 105 than those shown in FIG. 1. Further, the user device 106a, the user device 106b, and the user device 106c may be incorporated in a user device group 113. Each of the user device 106a, the user device 106b, and the user device 106c may be operated by a user 114a, a user 114b, and a user 114c, respectively. The user device groups 113 may comprise less or more user devices 106 than those shown in FIG. 1.

In one or more embodiments, the server 102 comprises the databases 118, a server input (I)/output (O) interfaces 120, at least one server processor 126 comprising a processing engine (not shown), and a server memory 130. In some embodiments, the databases 118 may be standalone memory storage units or part of the server memory 130. In some embodiments, the server memory 130 may comprise instructions 132, one or more communication groups 133 associating one or more device roles 134 with a messaging framework 135, one or more summaries 136, the one or more communication operations 104, one or more transcription operations 138 transcribing audio data 140 into image data 142 and/or text data 144, one or more system of records (SORs) 146, one or more authorized communication operations 148, one or more rules and policies 150, one or more directories 152 comprising one or more user profiles 154 associated with one or more entitlements 156 to access one or more services 158, one or more target operations 162, one or more action item suggestions 164, one or more reset points 166, one or more communication commands 168, and information associated with an analysis architecture comprising one or more machine learning (ML) algorithms 172 and one or more artificial intelligence (AI) commands 174 configured to train and/or perform one or more operations in accordance with one or more ML models 176.

Referring to the workspace device 105a as a non-limiting example of the workspace devices 105, the workspace devices 105 may comprise one or more device interfaces 182, one or more device peripherals 184, a device processor 186, and a device memory 190. The device memory 190 may comprise multiple device instructions 192, multiple local operation data, and one or more local applications. The user devices 106 may comprise one or more elements and/or components described in reference to the workspace device 105a.

### System Components

### Server

The server 102 is generally any device or apparatus that is configured to process data and communicate with computing devices (e.g., the workspace devices 105 and/or the user devices 106), additional databases, systems, and the like, via the one or more server I/O interfaces 120 (i.e., a user interface or a network interface). The server 102 may comprise the server processor 126 that is generally configured to oversee operations of the processing engine. The operations of the processing engine are described further below in conjunction with the system 100 described in FIG. 1, the operation flow 200 described in FIG. 2, the process 300 described in FIG. 3, the operation flows 400a-400g described in corresponding FIGS. 4A-4G, and the process 500 described in FIG. 5.

The server 102 comprises multiple databases 118 configured to provide one or more memory resources to the server 102, the workspace devices 105, and/or and the user devices 106. The server 102 comprises the server processor 126 communicatively coupled with the databases 118, the server I/O interfaces 120, and the server memory 130. The server 102 may be configured as shown, or in any other configuration. In one or more embodiments, the databases 118 are configured to store data that enables the server 102 to configure, manage and coordinate one or more middleware systems. In some embodiments, the databases 118 store data used by the server 102 to function as a halfway point in between applications and other tools or databases.

In one or more embodiments, the databases 118 may be one of the server databases in one of the managed servers. In one example, the server 102 may determine the server processor 126 is available (e.g., running) to perform a specific server application (e.g., service). In another example, the server 102 may determine that a specific managed server is running to perform a specific server application after receiving a server response indicating that a corresponding managed server is available to perform the server application. In one or more embodiments, the server 102 may determine whether a specific device processor 186 is available (e.g., running) to perform one or more specific local applications. In yet another example, the server 102 may determine that the databases 118 are running to provide memory resources to execute server applications receiving a database response indicating that the databases 118 are available to provide memory resources to execute the server applications. In one or more embodiments, the server 102 may determine whether the databases 118 are available (e.g., running) and may provide the database response. In one or more embodiments, one of the managed servers may determine whether the corresponding databases 118 are available (e.g., running) and may provide the database response.

In one or more embodiments, the server I/O interfaces 120 may be configured to enable wired and/or wireless communications. The server I/O interfaces 120 may be configured to communicate data between the server 102 and other devices (i.e., the workspace devices 105 and/or the user devices 106), network devices (i.e., routers in the network 110), systems, or domain(s) via the network 110. For example, the server I/O interfaces 120 may comprise a WI-FI interface, a LAN interface, a WAN interface, a modem, a switch, or a router. The server processor 126 may be configured to send and receive data using the server I/O interfaces 120. The server I/O interfaces 120 may be configured to use any suitable type of communication protocol. In some embodiments, the server I/O interfaces 120 may be an admin console comprising a display configured to show a user interface used to manage a middleware server domain via the server 102. A middleware server domain may be a logically related group of middleware server resources that managed as a unit. A middleware server domain may comprise the server 102 and one or more managed servers. The managed servers may be standalone devices and/or collected devices in a server cluster. The server cluster may be a group of managed servers that work together to provide scalability and higher availability for server applications. In this regard, the server applications are developed and deployed as part of at least one domain. In other embodiments, one instance of the managed servers in the middleware server domain may be configured as the server 102. The server 102 provides a central point for managing and configure the managed servers, any of the one or more server applications and the one or more local applications.

The at least one server processor 126 may comprise one or more processors communicatively coupled to the server memory 130. The server processor 126 may be any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The server processor 126 may be a programmable logic device, a microcontroller, a microprocessor, or any suitable combination of the preceding. The one or more server processors 126 may be configured to process data and may be implemented in hardware or software executed by hardware. For example, the server processor 126 may be 8-bit, 16-bit, 32-bit, 64-bit or of any other suitable architecture. The server processor 126 may include an arithmetic logic unit (ALU) for performing arithmetic and logic operations, processor registers that supply operands to the ALU and store the results of ALU operations, and a control unit that fetches the instructions 132 from the server memory 130 and executes them by directing the coordinated operations of the ALU, registers and other components. In this regard, the one or more server processors 126 are configured to execute various instructions. For example, the one or more server processors 126 are configured to execute the instructions 132 to implement the functions disclosed herein, such as some or all of those described with respect to FIGS. 1-5. In some embodiments, the functions described herein are implemented using logic units, FPGAs, ASICs, DSPs, or any other suitable hardware or electronic circuitry.

In one or more embodiments, the server I/O interfaces 120 may be any suitable hardware and/or software to facilitate any suitable type of wireless and/or wired connection. These connections may include, but not be limited to, all or a portion of network connections coupled to the Internet, an Intranet, a private network, a public network, a peer-to-peer network, the public switched telephone network, a cellular network, a local area network (LAN), a metropolitan area network (MAN), a wide area network (WAN), and a satellite network. The server I/O interfaces 120 may be configured to support any suitable type of communication protocol as would be appreciated by one of ordinary skill in the art.

The server memory 130 may be volatile or non-volatile and may comprise a read-only memory (ROM), random-access memory (RAM), ternary content-addressable memory (TCAM), dynamic random-access memory (DRAM), and static random-access memory (SRAM). The server memory 130 may be implemented using one or more disks, tape drives, solid-state drives, and/or the like. The server memory 130 is operable to store the instructions 132, the one or more communication groups 133 associating the one or more device roles 134 with the messaging framework 135, the one or more summaries 136, the one or more communication operations 104, the one or more transcription operations 138 transcribing stored and/or dynamically obtained audio data 140 into image data 142 and/or text data 144, the one or more SORs 146, the one or more authorized communication operations 148, the one or more rules and policies 150, the one or more directories 152 comprising the one or more user profiles 154 associated with the one or more entitlements 156 to access the one or more services 158, the one or more target operations 162, the one or more action item suggestions 164, the one or more reset points 166, the one or more communication commands 168, information associated with the analysis architecture comprising the one or more ML algorithms 172 and the one or more AI commands 174 configured to train and/or perform one or more operations in accordance with the one or more ML models 176, and/or any other data or instructions. The instructions 132 may comprise any suitable set of instructions, logic, rules, or code operable to execute the server processor 126.

The communication groups 133 may be one or more configuration commands configured to associate one or more of the workplace devices 105 with one or more specific roles 134 within an organization. The communication groups 133 may comprise access commands to one or more network resources indexed in specific namespaces and pods in a communication system. The network resources may be memory resources, processing resources, and/or power resources that one or more of the workspace devices 105 are configured to access in a process to perform one or more communication operations 104. The communication groups 133 may be one or more virtual spaces associated with one or more specific agents 112. In this regard, the communication groups 133 may be customer service representative (CSR) workspaces configured to communicate with one or more user devices 106 associated with one or more users 114. The device roles 134 may provide the workspace devices 105 with one or more guidelines and/or configuration parameters to perform one or more of the communication operations 104. For example, first device roles 134a may indicate that the workspace device 105a is configured to access a first database 118a and second device roles 134b may indicate that the workspace device 105b is configured to access a second database 118b that is different from the first database 118a. The messaging framework 135 may be one or more protocols and/or communication procedures that guide interactions (e.g., sound and/or visual communications) between the server 102, one or more of the workspace devices 105, and/or one or more of the user devices 106. The messaging framework 135 may be configured to provide access between the directories 152 and one or more of the workspace devices 105.

The one or more communication operations 104 may be one or more data exchanges performed between two or more network devices in the system 100. The network devices may comprise the server 102, one or more of the workspace devices 105, and one or more of the user devices 106 among others. In one or more embodiments, the communication operations 104 may be audio communications exchanged as part of audio conversations (e.g., during a telephonic call) between two or more network devices. The communication operations 104 may be image and/or text communications exchanged as part of image-based conversations (e.g., during videocalls and/or chat exchanges) between two or more network devices.

The transcription operations 104 may be one or more operations to transcribe audio data 140 into image data 142 and/or text data 144. The audio data 140 may be obtained from audio signaling exchanges between network devices in the system 100. The audio data 140 may be an audio signature representative of one or more speech patterns and/or human sounds comprising a frequency range of 10 Hertz (Hz) to 30 kilohertz (kHz), inclusive. The audio data 140 may be any sound exchanged between two or more network devices. In one or more embodiments, the image data 142 may be codified images comprising one or more machine-readable codes representative of the audio data 140. The text data 144 may be letters and/or numbers. In one or more embodiments, the transcription operations 138 may be performed as part of one or more speech-to-text transcription operations 138 in real time as sounds are shared between two or more network devices. For example, the server 102 may be configured to transcribe audio data 140 exchanged between one of the workplace devices 105 (e.g., the workplace device 105a) and one of the user devices 106 (e.g., the user device 106a) in real time and/or near-real time.

In one or more embodiments, the server 102 may be configured to identify a communication operation 104 in which an audio stream is exchanged between one of the workplace devices 105 (e.g., the workplace device 105a) and one of the user devices 106 (e.g., the user device 106a). Herein, the server 102 may be configured to determine audio data 140 in the audio stream and dynamically transcribe the audio data 140 into image data 142 and/or text data 144. The transcription operations 138 may be performed after executing one or more ML algorithms 172 and one or more AI commands 174 trained in accordance with one or more ML models 176 in an analysis architecture. In turn, the transcribed data may be provided to an intelligent conversation hub (ICH) configured to structure and analyze the transcribed data. In some embodiments, the transcribed data may be a transcript showing lines of text or any other suitable combination of images and/or text. The ICH may be a conversation management framework that considers information in the directories 152 in accordance with a natural language understanding system to determine intent behind a user 114a associated with a user device 106a.

In one or more embodiments, the server 102 may be configured to execute the ML algorithm 172 to generate one or more summaries 136 based on the image data 142 and/or the text data 144. The summaries 136 may be one or more brief call purpose summaries indicating possible motivation behind statements in the audio data 140. The summaries 136 may be evaluated in accordance with a classification model to determine an intent related to statements in the audio data 140. The image data 142 and/or the text data 144 may be analyzed in accordance a language model (e.g., such as the Bidirectional and Auto-Regressive Transformer (BART)) to perform one or more summarization processes. In some embodiments, each of the summaries 136 may be a request summary in text data 144. The request summary may be representative of a predicted purpose behind a specific communication operation 104 associated with the audio data 144.

The communication SORs 146 may be services that execute one or more actions after identifying a trigger from the server 102. The communication SORs 146 may be configured to provide bridge connectivity between the workspace devices 105 and the services 158. For example, a workspace device 105a may be configured to generate one or more action item suggestions 164 based on intentions determined behind communication operations 104 performed by the network devices. In some embodiments, action item suggestions 164 may be provided to one or more of the workspace devices 105. In turn, a given workspace device 105a may be configured to perform the suggested action item.

The rules and policies 150 may be security configuration commands or regulatory operations predefined by an organization or one or more users 114. In one or more embodiments, the rules and policies 150 may be dynamically defined by the one or more users 114. The rules and policies 150 may be prioritization rules configured to instruct the server 102, the one or more user devices 106, and/or the one or more workspace devices 105 to perform one or more audio analysis operations or perform one or more communication operations 104 in the system 100. The one or more rules and policies 150 may be predetermined or dynamically assigned by a corresponding user 114, a corresponding agent 112, and/or an organization associated with the users 114 and/or the agents 112.

The directories 152 may comprise the one or more user profiles 154, one or more entitlements 156, and one or more services 158. In one or more embodiments, the user profiles 154 may comprise multiple profiles associated with one or more entitlements 156 to access and/or modify the services 158. Each of the user profiles 154 may be associated with one or more entitlements 156. The entitlements 156 may indicate that a given user device 106 is allowed to access one or more network resources in accordance with the one or more rules and policies 150. The entitlements 156 may indicate that a given user device 106 is allowed to perform one or more operations in the system 100 (e.g., provide a specific application data access to one of the users 114). To secure or protect operations of the user devices 106 from bad actors, the entitlements 156 may be assigned to a given user profile 154 in accordance with updated security information, which may provide guidance parameters to the use of the entitlements 156 based at least upon corresponding rules and policies 150. In one or more embodiments, the one or more services 158 are access to one or more application operations performed in accordance with the application data. In some embodiments, the user profiles 154 may comprise multiple profiles for users (e.g., user 114). Each user profile 154 may comprise one or more entitlements 156. As described above, the entitlements 156 may indicate that a given user 114 is allowed to access one or more network resources in accordance with one or more rules and policies 150. The entitlements 156 may indicate that a given user is allowed to perform one or more data exchanges in the system 100. In one or more embodiments, each of the user profiles 154 may comprise information about at least one user 114 entitled to trigger one or more data exchange operations and/or communication operations 104.

The target operations 162 may be representative of one or more intents to perform a specific communication operation 104. The target operations 162 may be one or more action items to be performed to at least partially fulfill the intent associated with the audio data 140. In some embodiments, the target operations 162 may be one or more operations to be performed to at least partially fulfill the intent behind the audio data 140. The target operations 162 may be mapped to one or more suggestions 164. Each suggestion 164 may comprise one or more action items to complete, perform, and/or trigger one or more target operations 162. The action items may be one or more operations, commands, and/or triggers to be performed in association with one or more of the workspace devices 105. The possible action items suggestions 164 may be recommendations presented to one or more of the workspace devices 105 based on the summaries 136 and/or the target operations 162. The possible action items suggestions 164 may comprise one or more dynamic configuration commands to modify the one or more entitlements 156. In one or more embodiments, the dynamic configuration commands may comprise one or more application configuration parameters configured to control operations of the services 158 (e.g., applications). Each configuration command of the application configuration parameters may be configured to dynamically provide control information to perform one or more of the operations based at least in part upon the evaluated audio data. The possible action items suggestions 164 provide preventive solutions to changes in a release that may cause unintended impacts to the services 158. In any integrated system where multiple services 158 interact with each other, the system 100 may thoroughly perform impact checks of any changes to operations and whether modifications are needed to ensure any change is not impacting performance of the services 158 upstream/downstream in the system 100.

In one or more embodiments, the server 102 may be configured to generate the one or more target operations 162 based at least in part one or more metadata elements identified during communication operations 104 exchanged between two or more network devices. The metadata may be related to routing information and/or transmission operations performed to exchange the audio data 140. The metadata elements may be one or more information elements associated with the directories 152.

In one or more embodiments, the audio data 140 received from a user device 106a may be handled by a voice gateway configured to forward audio streams to a speech-to-text model. The text-to-speech model may be an ML model 176 configured to filter out background noise in an audio stream and identify human speech and execute an ML algorithm 172 to transcribe the audio data 140 associated with the human speech. The transcribed version of the audio data 140 may be image data 142 and/or text data 144. At this stage, the ML algorithm 172 may be executed in accordance with a call purpose summarization model to summarize the transcribed data and generate one or more summaries 136 as a result. The ML algorithms 172 may be executed in accordance with a classification model to determine information and/or communication categories associated with the audio data 140. The ML algorithms 172 may be configurated to evaluate the summaries 136 in accordance with a Named Entity Recognition (NER) model to extract entities (e.g., names, dates, accounts, amounts, numbers, and the like) from the summaries 136.

In one or more embodiments, the server 102 is configured to identify one or more communication operations 104, determine audio data 140 in the communication operations 104, and generate one or more summaries 136 based on the audio data 140. The summaries 136 may be configured to represent a purpose behind the audio data 140. As the communication operations 104 continue, subsequent audio data 140 is used to generate additional summaries 136. For each of the summaries 136, the server 102 may be configured to determine one or more target operations 162 indicating intent from at least a portion of the communication operations 104. As the summaries 136 are obtained, additional target operations 162 may be determined over time. As each of the target operations 162 are determined, the server 102 may be configured to evaluate each of the corresponding intents to identify potential action item suggestions 164 with respect to a starting point (e.g., a starting intent). At a time when the server 102 starts obtaining the audio data 140, a first intent associated with a first target operations 162 may be the starting point.

In one or more embodiments, as new intents are determined, if a new intent is determined to be mapped to one or more action item suggestions 164, then the new intent is referenced as a reset point 166 to evaluate subsequent intents to map to additional action item suggestions 164. In this regard, the server 102 may be configured to dynamically determine and/or predict an intent and determine whether the intent may be mapped to an action item suggestion 164 based on the predicted intent of specific audio data 140. In turn, the action item suggestions 164 are provided to one or more of the workspace devices 105 configured to perform the action item suggestions 164. In some embodiments, the action item suggestions 164 may be provided to the workspace devices 105 via one or more of the device interfaces 182. For example, the action item suggestions 164 may be presented in a device interface 182 comprising a display in the form of an image, text, and/or notification.

In some embodiments, the intents (e.g., reset points 166) may be used to train one or more of the ML models 176. Herein, the ML algorithm 172 may be executed to train the ML models 176 to account for the communication operations exchanged between two or more network devices as context for the determined intents. In this regard, the ML models 176 are trained to proactively determine future intents from communication operations 104.

The authorized communication operations 148 may be communication operations 104 that are determined to be permitted within an organization. For example, the system 100 may comprise authorized communication operations 148 that permit the workspace devices 105 to modify one or more entitlements 156 to access a specific service 158. In one or more embodiments, an intent indicated in a target operation 162 may be associated with a corresponding communication operation 104. In some embodiments, the intent and/or the corresponding communication operation 104 may be compared to the authorized communication operations 148. If the intent and/or the corresponding communication operation 104 are determined to at least partially match the authorized communication operations 148, then the intent is stored as a new reset point 166. Herein, the new reset points 166 may be used to train the ML algorithms 172 and/or the ML models 176. If the intent and/or the corresponding communication operation 104 are not determined to at least partially match the authorized communication operations 148, then the intent is not stored as a new reset point 166. Herein, the new reset points 166 may not be used to train the ML algorithms 172 and/or the ML models 176.

In some embodiments, the communication commands 168 provide triggers in the form of communication or control signals to start operations such as fetching the instructions 132 or running one or more scripts. The communication commands 168 may provide service information data indicating any services (e.g., one or more of the services 158) available in the server 102, the workspace devices 105, and the user devices 106. The communication commands 168 may provide lists, security information, and configuration parameters that the server 102 uses to set up a communication operation 104. The communication commands 168 may be configuration data that provides starting procedure configuration to the server 102. In one or more embodiments, the communication commands 168 may be optimized instructions that enable establishing of a specific procedure in the workspace devices 105 and/or the user devices 106.

In one or more embodiments, the analysis architecture 170 comprises the ML algorithms 172, the AI commands 174, and the ML models 176. The ML algorithms 172 may be executed by the server processor 126 to evaluate the audio data 140 and/or perform one or more of the transcription operations 138 in accordance with one or more ML models 176. Further, the ML algorithms 172 may be configured to interpret and transform the audio data 140, the image data 142, and/or the text data 144 into structured data sets and subsequently stored as files or tables. The ML algorithms 172 may cleanse, normalize raw data, and derive intermediate data to generate uniform data in terms of encoding, format, and data types. The ML algorithms 172 may be executed to run user queries and advanced analytical tools on the structured data. The ML algorithms 172 may be configured to generate the one or more AI commands 174 based on a current service 158 and the existing communication commands 168. In turn, the server processor 126 may be configured to generate the possible action item suggestions 164 based on the outputs of the ML algorithms 172. The AI commands 174 may be parameters that modify the possible action item suggestions 164. The AI commands 174 may be combined with the existing communication commands 168 to create the possible action item suggestions 164.

### Network

The network 110 facilitates communication between and amongst the various devices of the system 100. The network 110 may be any suitable network operable to facilitate communication between the server 102, the workspace devices 105, and the user devices 106 of the system 100. The network 110 may include any interconnecting system capable of transmitting audio, video, signals, data, data packets, messages, or any combination of the preceding. The network 110 may include all or a portion of a public switched telephone network (PSTN), a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the devices.

### Workspace Devices

In one or more embodiments, each of the workspace devices 105 (e.g., the workspace devices 105a-105d) may be any computing device configured to communicate with other devices, such as the server 102, other workspace devices 105 in additional workspace device groups 111, the user devices 106 in the user device group 113, other user devices 106 in additional user devices 106, databases, and the like in the system 100. Each of the workspace devices 105 may be configured to perform specific functions described herein and interact with one or more workspace devices 105b-105d in the user device group 113. Examples of the workspace devices 105 comprise, but are not limited to, a laptop, a computer, a smartphone, a tablet, a smart device, an IoT device, a simulated reality device, an augmented reality device, or any other suitable type of device. In some embodiments, the workspace devices 105 may be associated with one or more of the communication groups 133. In this regard, each of the workspace devices 105 may be associated with one or more specific roles 134 within an organization. Further, each of the workspace devices 105 may comprise access and/or connectivity to one or more elements of the messaging network in accordance with corresponding device roles 134.

The workspace devices 105 may be hardware configured to create, transmit, and/or receive information. The workspace devices 105 may be configured to receive inputs from a user, process the inputs, and generate data information or command information in response. The data information may include documents or files generated using a user interface. The command information may include input selections/commands triggered by a user using a peripheral component or one or more device peripherals 184 (i.e., a keyboard) or an integrated input system (i.e., a touchscreen presenting a user interface). The workspace devices 105 may be communicatively coupled to the server 102 via a network connection (i.e., one or more of the device interfaces 182). The workspace devices 105 may transmit and receive data information, command information, or a combination of both to and from the server 102 via the device interfaces 182. In one or more embodiments, the workspace devices 105 is configured to exchange data, commands, and signaling with the server 102. In some embodiments, the workspace devices 105 are configured to trigger the start of one or more communication operations. The workspace devices 105 may be configured to trigger network devices to perform one or more communication operations. In one or more embodiments, while FIG. 1 shows the workspace device 105b, the workspace device 105c, and the workspace device 105d, a given workspace device group 111 may comprise less or more workspace devices 105.

In one or more embodiments, referring to the workspace device 105a as a non-limiting example of the workspace devices 105, the workspace device 105a may comprise one or more device interfaces 182, one or more device peripherals 184, a device processor 186, and a device memory 190. The device interfaces 182 may be any suitable hardware or software (e.g., executed by hardware) to facilitate any suitable type of communication in wireless or wired connections. These connections may comprise, but not be limited to, all or a portion of network connections coupled to additional workspace devices 105b-105d, the server 102, the user devices 106, the Internet, an Intranet, a private network, a public network, a peer-to-peer network, the public switched telephone network, a cellular network, a LAN, a MAN, a WAN, and a satellite network. The device interfaces 182 may be configured to support any suitable type of communication protocol.

In one or more embodiments, the one or more device peripherals 184 may comprise audio devices (e.g., speaker, microphones, and the like), input devices (e.g., keyboard, mouse, and the like), or any suitable electronic component that may provide a modifying or triggering input to the workspace device 105a. For example, the one or more device peripherals 184 may be speakers configured to release audio signals (e.g., voice signals or commands) during media playback operations. In another example, the one or more device peripherals 184 may be microphones configured to capture audio signals from the agent 112a. In one or more embodiments, the one or more device peripherals 184 may be configured to operate continuously, at predetermined time periods or intervals, or on-demand.

The device processor 186 may comprise one or more processors communicatively coupled to and in signal communication with the device interfaces 182, the device peripherals 184, and the device memory 190. The device processor 186 is any electronic circuitry, including, but not limited to, state machines, one or more CPU chips, logic units, cores (e.g., a multi-core processor), FPGAs, ASICs, or DSPs. The device processor 186 may be a programmable logic device, a microcontroller, a microprocessor, or any suitable combination of the preceding. The one or more processors in the device processor 186 are configured to process data and may be implemented in hardware or software executed by hardware. For example, the device processor 186 may be an 8-bit, a 16-bit, a 32-bit, a 64-bit, or any other suitable architecture. The device processor 186 comprises an ALU to perform arithmetic and logic operations, processor registers that supply operands to the ALU, and store the results of ALU operations, and a control unit that fetches software instructions such as device instructions 192 from the device memory 190 and executes the device instructions 192 by directing the coordinated operations of the ALU, registers, and other components via a device processing engine (not shown). The device processor 186 may be configured to execute various instructions. For example, the device processor 186 may be configured to execute the device instructions 192 to implement functions or perform operations disclosed herein, such as some or all of those described with respect to FIGS. 1-5. In some embodiments, the functions described herein are implemented using logic units, FPGAs, ASICs, DSPs, or any other suitable hardware or electronic circuitry.

In one or more embodiments, the device memory 190 may comprise multiple local operation data and one or more local applications associated with the server 102. The local operation data may be data configured to enable one or more data processing operations such as those described in relation with the server 102. The local operation data may be partially or completely different from those comprised in the server memory 130. The local applications may be one or more of the services described in relation with the server 102. In some embodiments, the local applications may be partially or completely different from those comprised in the server memory 130.

### User Devices

In one or more embodiments, each of the user devices 106 (e.g., the user devices 106a-106c) may be any computing device configured to communicate with other devices, such as the server 102, the workspace device 105a, the workspace devices 105b-105d in the workspace device group 111, other user devices 106 in other user device groups 113, databases, and the like in the system 100. Each of the user devices 106 may be configured to perform specific functions described herein and interact with one or more user devices 106a-106c in the user device group 113. Examples of the user devices 106 comprise, but are not limited to, a laptop, a computer, a smartphone, a tablet, a smart device, an IoT device, a simulated reality device, an augmented reality device, or any other suitable type of device. The user devices 106 may comprise some of capabilities described in reference to the workspace device 105a. In some embodiments, while FIG. 1 shows the user device 106a, the user device 106b, and the user device 106c, a given user device group 113 may comprise less or more workspace devices 105.

### Operational Flow to Evaluate Audio Data

FIG. 2 shows an operational flow 200 in which the system 100 of FIG. 1 is configured to evaluate audio data 140, in accordance with one or more embodiments. In FIG. 2, the operational flow comprises multiple operations 202-220. The operational flow 200 may be performed between a user device 106a associated with a user 114a and an agent 112a associated with a workspace device 105a. The operational flow 200 shows elements and/or components comprising the user device 106a, a voice gateway 230, a workspace device 105a, a conversation management framework 232, an analysis operator 234, and the analysis architecture 170 communicatively coupled to one another. The analysis architecture may comprise the one or more ML algorithms 172, the one or more AI commands 174, and the ML models 176 comprising one or more recognition models 240, one or more classification models 242, one or more summarization models 244, and one or more AI models 250.

In one or more embodiments, at operations 202, a user device 106a may be configured to provide one or more sounds to the voice gateway 230. For example, the user device 106a may connect to the voice gateway 230 during a telephonic call. The voice gateway 230 may be hardware and/or software executed by hardware located in the server 102 and/or the network 110. At operations 204, the voice gateway 230 may be configured to provide a stream of audio data 140 to the server 102 configured to perform one or more transcription operations 138. As part of the transcription operations 138, after execution of the ML algorithms 172, the server 102 may be configured to coordinate transcription of the audio data 140 in the stream of audio data 140 to image data 142 and/or text data 144 in accordance with one or more AI models 250. At operation 208, the transcription operations 138 may provide the transcribed image data 142 and/or text data 144 to a conversation management framework 232. The conversation management framework 232 may be the ICH located in the server 102. At operations 210, the conversation management framework 232 may be configured to receive sounds and/or additional responses from the workspace device 105a.

In some embodiments, at operations 212, the conversation management framework 232 may be configured to provide an analysis operator 234 located in the server 102 and configured to dynamically summarize and evaluate the audio data 140 using the analysis architecture 170. At operations 214, the analysis operator 234 may perform one or more summarization operations to create the one or more summaries 136 after executing the ML algorithms 172 in accordance with the one or more summarization models 244. At operations 216, the analysis operator 234 may perform one or more classification operations to sort the one or more summaries 136 after executing the ML algorithms 172 in accordance with the one or more classification models 242. At operations 218, the analysis operator 234 may perform one or more recognition operations to determine the one or more target operations 162 after executing the ML algorithms 172 in accordance with the one or more recognition models 240. Herein, the operational flow 200 is configured to determine purposes associated with the audio data 140 received from the user device 106a. Over time, the server 102 may be configured to determine one or more intents associated with the audio data 140. At operations 220, the communication SORs 146 may be used to perform one or more smart searches in the databases 118. The smart searches may be coordinated searches in which action item suggestions 164 are identified, obtained, and/or generated. As possible action item suggestions 164 are determined, the server 102 may be configured to map one or more of the target operations 162 to one or more corresponding action item suggestions 164. At this stage, the server 102 may be configured to present the mapped action item suggestion 164 to the workspace device 105a via one or more of the operations 210. The workspace device 105a may present the mapped action item suggestion 164 via one of the device interfaces 182 in accordance with one or more communication commands 168.

In one or more embodiments, the presented action item suggestions 164 are shown in a display in the workspace device 105a along with one or more interactive elements. In this regard, interactions with images and/or text representing the action item suggestions 164 may provide additional information that expands on possible additional action items that may fulfill any explicit and/or intrinsic requests in the audio data 140 over time.

In one or more embodiments, the operational flow 200 may comprise observing communication operations 104 performed between the user device 106a and the workspace device 105a. Further, the server 102 may be configured to dynamically provide automatic recommendations to the workspace device 105a on next actions to perform. The next actions may be one or more action item suggestions 164 to at least partially trigger and/or fulfill requests identified in audio data exchanged by the user device 106a. In this regard, the server 102 may automate possible operations associated with the action item suggestions 164. For example, the action item suggestions 164 may enable the agent 112a to navigate to specific screens to assist with one or more of the requests, pre-fill information to increase selection speed of options relevant to information being exchanged and find information relevant to the requests. In the workspace device 105a, the action item suggestions 164 may be presented as recommendations for the agent 112a to act on. In some embodiments, the action item suggestions 164 may be performed automatically in accordance with a confidence level associated with the determined intent. In this regard, the server 102 may generate a report (e.g., a message and/or a control notification) that is presented in the workspace device 105a to indicate that an action item suggestion 164 was performed.

### Example Process to Evaluate Audio Data

FIG. 3 illustrates an example flowchart of a process 300 configured to evaluate audio data, in accordance with one or more embodiments. Modifications, additions, or omissions may be made to the process 300. The process 300 may comprise more, fewer, or other operations than those shown in FIG. 3. For example, operations may be performed in parallel or in any suitable order. While at times discussed as the server 102, the user devices 106, or components of any of thereof performing operations described in operations 302-326 in the process 300, any suitable system or components of the system 100 may perform one or more operations of the process 300. For example, one or more operations of the process 300 may be implemented, at least in part, in the form of instructions 132 of FIG. 1, stored on non-transitory, tangible, machine-readable media (e.g., a non-transitory computer readable medium such as server memory 130 of FIG. 1) that when run by one or more processors (e.g., the server processor 126 of FIG. 1) may cause the one or more processors to perform operations described in operations 302-326.

The process 300 starts at operation 302, where the server 102 obtains audio data 140 from a user device 106a. In some embodiments, prior to obtaining the audio data 140 from the user device 106a, the server 102 may be configured to identify a communication exchange between the user device 106a and the workspace device 105a. In the communication exchange, the user device 106a may be authenticated by the workspace device 105a as being entitled to access one or more services 158. For example, the server 102 may be configured to identify conversations between the user device 106a and the workspace device 105a prior to evaluating any audio data 140. At operation 304, the server 102 is configured to execute the ML algorithm 172 to transcribe the audio data 140 into image data 142 and/or text data 144. The server 102 may be configured to transcribe multiple packets of audio data 140 over time. At operation 306, the server 102 is configured to generate a request summary (e.g., one of the summaries 136) based on the text data 144. The request summary may be representative of a predicted purpose associated with the audio data 140. For example, the server 102 may be configured to summarize the text data 144 down to one or two sentences to determine a current conversation purpose. There may be multiple conversation purposes over time. At operation 308, the server 102 is configured to determine a target operation 162 based on the request summary. The target operation 162 may be and/or indicate a determined intent to perform a specific communication operation 104. Each of the summaries 136 may be fed to the classification models 242 to predict each corresponding intent. The summarization operations may be performed with generative AI upon execution of the ML algorithms 172. In classification models 242, the server 102 may be configured to sort the text data 144 into various groups based on a most probable representation of intent dynamically inferred from the text data 144.

At operation 310, the server 102 is configured to determine whether there are any suggestions to achieve the target operation 162. If the server 102 determines that there are any suggestions to achieve the target operation 162 (e.g., YES), the process 300 proceeds to operation 322. At operation 322, the server 102 is configured to map the target operation 162 to an action item suggestion 164. The action item suggestion 164 may comprise one or more action items configured to complete the target operation 162. If the server 102 determines that there are no suggestions to achieve the target operation 162 (e.g., NO), the process 300 proceeds to operation 312. At operation 312, the server 102 is configured to map the target operation 162 to an action item suggestion 164. The server 102 may generate a suggestion comprising action items to achieve the target operation 162.

The process 300 may end at operation 324, where the server 102 may be configured to present the action item suggestion 164 to the workplace device 105a. The server 102 may be configured to present the action item suggestion 164 to a device interface 182 and/or a device peripheral 184 in the workspace device 105a. In some embodiments, in response to presenting the action item suggestion 164 to the workspace device 105a, the workspace device 105a may be configured to perform an update of a user interface (UI) in the workspace device 105a. Further, in response to presenting subsequent action item suggestions 164 to the workspace device 105a, the workspace device 105a is configured to perform additional updates to the UI. In some embodiments, the subsequent updates may comprise replacing current action item suggestions 164 with newer action item suggestions 164.

### Operational Flow to Generate Information Requests Based on Audio Data

FIGS. 4A-4G show respective operational flows 400a-400g in which the system 100 is configured to generate information requests based on audio data 140, in accordance with one or more embodiments. In FIG. 4A, the operational flow 400a comprises operations 402-406. In FIG. 4B, the operational flow 400b comprises operations 410-418. In FIG. 4C, the operational flow 400c comprises operations 420-432. In FIG. 4D, the operational flow 400d comprises operations 434-450. In FIG. 4E, the operational flow 400e comprises operations 466-470. In FIG. 4F, the operational flow 400f comprises operations 472-480. In FIG. 4G, the operational flow 400g comprises operations 482-494. In some embodiments, the operations 402-494 may be performed as part of processes configured to determine intent behind audio data 140 exchanged between one of the workspace devices 105 and one of the user devices 106.

In one or more embodiments, the server 102 is configured to determine intents based on the summaries 136 determined based on the audio data 140. Herein, the intents are determined in accordance with a three-branch technique configured to account for a most recent summary request, a most recent and previous summary request; and most recent summary request associated with an authorized communication operation 148. In this regard, intent is evaluated to generate one or more of the reset points 166 such that new target operations 162 are evaluated dynamically with respect to intents that are determined to at least partially match one or more authorized communication operations 148. Each intent may be associated with a specific communication operation. As described above, the server 102 may be configured to compare the intent and/or the corresponding communication operation 104 to the authorized communication operations 148. If the intent and/or the corresponding communication operation 104 are determined to at least partially match the authorized communication operations 148, then the intent is stored as a new reset point 166. Herein, the new reset points 166 may be used to train the ML algorithms 172 and/or the ML models 176. If the intent and/or the corresponding communication operation 104 are not determined to at least partially match the authorized communication operations 148, then the intent is not stored as a new reset point 166. Herein, the new reset points 166 may not be used to train the ML algorithms 172 and/or the ML models 176.

FIG. 4A comprises the operations 402-406 comprising a user input U1, a purpose summary S1, and a predicted intent I1. At operations 402, the user input U1 may be first audio data 140 obtained from a user device 106a. The user inputs may be audio data collected over a period of time. The period of time may be a predetermined time duration. The period of time may be a dynamically assigned time duration. At operations 404, the purpose summary S1 may be determined based on a first summary 136 obtained from the first audio data 160. At operations 406, the predicted intent I1 may be determined as a first intent indicated in a first target operation 162 based on the first summary 136. In the operational flow 400a, the server 102 may compare a first communication operation 104 associated with the first intent with the authorized communication operations 148. Further, the server 102 may determine that the first communication operation 104 does not match the authorized communication operations 148.

FIG. 4B comprises the operations 410-418 comprising user input U1 through user input U2, a purpose summary S2, a predicted intent I2, a purpose summary S1,2, and a predicted intent I1,2. At operations 410, the user input U1 through user input U2 may be the first audio data 140 and second audio data 140 obtained from the user device 106a. At operations 412, the purpose summary S2 may be determined based on a second summary 136 obtained from the second audio data 160. At operations 414, the predicted intent I2 may be determined as a second intent indicated in a second target operation 162 based on the second summary 136. At operations 416, the purpose summary S1,2 may be determined based on the first summary 136 obtained from the first audio data 160 and the second summary 136 obtained from the second audio data 160. At operations 418, the predicted intent I1,2 may be determined as a combined intent indicated based on the first target operation 162 and the second target operation 162. In the operational flow 400b, the server 102 may compare a second communication operation 104 associated with the combined intent with the authorized communication operations 148. Further, the server 102 may determine that the second communication operation 104 does not match the authorized communication operations 148.

FIG. 4C comprises the operations 420-432 comprising user input U1 through user input U3, a purpose summary S3, a predicted intent I3, a purpose summary S2,3, a predicted intent I2,3, a purpose summary SH,3, and a predicted intent IH,3. In the operational flow 400c, the letter “H” indicates a history reset point based on when a most recent authorized communication operation 148. In this case, the first intent is considered as the most recent authorized communication operation 148 because an actual authorized communication operation 148 is not determined since the start of the evaluation process. Thus, H equals 1 in reference to the first input. In the scenario shared in FIGS. 4A-4C, allowable intent is not yet predicted and the reset point 166 is the first intent. At operations 420, the user input U1 through user input U3 may be the first audio data 140, the second audio data 140, and third audio data 140 obtained from the user device 106a. At operations 422, the purpose summary S3 may be determined based on a third summary 136 obtained from the third audio data 160. At operations 424, the predicted intent I3 may be determined as a third intent indicated in a third target operation 162 based on the third summary 136. At operations 426, the purpose summary S2,3 may be determined based on the second summary 136 obtained from the second audio data 160 and the third summary 136 obtained from the third audio data 160. At operations 428, the predicted intent I2,3 may be determined as a first combined intent indicated based on the second target operation 162 and the third target operation 162. At operations 430, the purpose summary SH,3 (e.g., a purpose summary S1,3) may be determined based on the first summary obtained from the first audio data 160, the second summary 136 obtained from the second audio data 160, and the third summary 136 obtained from the third audio data 160. At operations 432, the predicted intent IH,3 (e.g., a predicted intent I1,3) may be determined as a second combined intent indicated based on the first target operation 162, the second target operation 162, and the third target operation 162. In the operational flow 400c, the server 102 may compare a third communication operation 104 associated with the second combined intent with the authorized communication operations 148. Further, the server 102 may determine that the third communication operation 104 does not match the authorized communication operations 148.

FIG. 4D comprises the operations 434-450 comprising user input U1 through user input U4, a purpose summary S4, a predicted intent 14, a purpose summary S3,4, a predicted intent I3,4, a purpose summary SH,4, and a predicted intent IH,4. In the operational flow 400d, H equals 1 in reference to the first input. At operations 434, the user input U1 through user input U4 may be the first audio data 140, the second audio data 140, the third audio data 140, and a fourth audio data 140 obtained from the user device 106a. At operations 436, the purpose summary S4 may be determined based on a fourth summary 136 obtained from the fourth audio data 160. At operations 438, the predicted intent 14 may be determined as a fourth intent indicated in a fourth target operation 162 based on the fourth summary 136. At operations 440, the purpose summary S3,4 may be determined based on the third summary 136 obtained from the third audio data 160 and the fourth summary 136 obtained from the fourth audio data 160. At operations 446, the predicted intent I3,4 may be determined as a first combined intent indicated based on the third target operation 162 and the fourth target operation 162. At operations 448, the purpose summary SH,4 (e.g., a purpose summary S1,4) may be determined based on the first summary obtained from the first audio data 160, the second summary 136 obtained from the second audio data 160, the third summary 136 obtained from the third audio data 160, and the fourth summary 136 obtained from the fourth audio data 160. At operations 450, the predicted intent IH,3 (e.g., a predicted intent I1,4) may be determined as a second combined intent indicated based on the first target operation 162, the second target operation 162, the third target operation 162, and the fourth target operation 162. In the operational flow 400d, the server 102 may compare a fourth communication operation 104 associated with the second combined intent with the authorized communication operations 148. Further, the server 102 may determine that the fourth communication operation 104 matches the authorized communication operations 148. In this case, the fourth intent is saved as a new reset point 166 and user input U1 through user input U4 are removed because an allowable intent is predicted.

FIG. 4E comprises the operations 466-470 comprising a user input U5, a purpose summary S5, and a predicted intent 15. At operations 466, the user input U5 may be fifth audio data 140 obtained from the user device 106a. At operations 468, the purpose summary S5 may be determined based on a fifth summary 136 obtained from the fifth audio data 160. At operations 470, the predicted intent 15 may be determined as a fifth intent indicated in a fifth target operation 162 based on the fifth summary 136. In the operational flow 400e, the server 102 may compare a fifth communication operation 104 associated with the fifth intent with the authorized communication operations 148. Further, the server 102 may determine that the fifth communication operation 104 does not match the authorized communication operations 148. FIG. 4F comprises the operations 472-480 comprising user input U5 through user input U6, a purpose summary S6, a predicted intent I6, a purpose summary S5,6, and a predicted intent 15,6. At operations 472, the user input U1 through user input U2 may be the fifth audio data 140 and sixth audio data 140 obtained from the user device 106a. At operations 474, the purpose summary S6 may be determined based on a sixth summary 136 obtained from the sixth audio data 160. At operations 476, the predicted intent I6 may be determined as a sixth intent indicated in a sixth target operation 162 based on the sixth summary 136. At operations 478, the purpose summary S5,6 may be determined based on the fifth summary 136 obtained from the fifth audio data 160 and the sixth summary 136 obtained from the sixth audio data 160. At operations 480, the predicted intent 15,6 may be determined as a combined intent indicated based on the fifth target operation 162 and the sixth target operation 162. In the operational flow 400f, the server 102 may compare a sixth communication operation 104 associated with the combined intent with the authorized communication operations 148. Further, the server 102 may determine that the sixth communication operation 104 does not match the authorized communication operations 148.

FIG. 4G comprises the operations 482-494 comprising user input U5 through user input U7, a purpose summary S7, a predicted intent I7, a purpose summary S6,7, a predicted intent I6,7, a purpose summary SH,7, and a predicted intent IH,7. In the operational flow 400g, the letter “H” indicates a history reset point based on when a most recent authorized communication operation 148. In this case, the fourth intent is considered as triggering the most recent authorized communication operation 148. Thus, H equals 5 in reference to the fifth input. At operations 482, the user input U5 through user input U7 may be the fifth audio data 140, the sixth audio data 140, and seventh audio data 140 obtained from the user device 106a. At operations 484, the purpose summary S7 may be determined based on a seventh summary 136 obtained from the seventh audio data 160. At operations 486, the predicted intent I7 may be determined as a seventh intent indicated in a seventh target operation 162 based on the seventh summary 136. At operations 488, the purpose summary S6,7 may be determined based on the sixth summary 136 obtained from the sixth audio data 160 and the seventh summary 136 obtained from the seventh audio data 160. At operations 490, the predicted intent I6,7 may be determined as a first combined intent indicated based on the sixth target operation 162 and the seventh target operation 162. At operations 492, the purpose summary SH,7 (e.g., a purpose summary S5,7) may be determined based on the fifth summary obtained from the fifth audio data 160, the sixth summary 136 obtained from the sixth audio data 160, and the seventh summary 136 obtained from the seventh audio data 160. At operations 494, the predicted intent IH,7 (e.g., a predicted intent 15,7) may be determined as a second combined intent indicated based on the fifth target operation 162, the sixth target operation 162, and the seventh target operation 162. In the operational flow 400g, the server 102 may compare a seventh communication operation 104 associated with the second combined intent with the authorized communication operations 148. Further, the server 102 may determine that the seventh communication operation 104 does not matches the authorized communication operations 148. In this case, if the communication operations 104 continue between the workspace device 105a and the user device 106a, the seventh intent is saved as a new reset point 166 and user input U5 through user input U7 are removed because a new allowable intent is predicted.

### Example Process to Generate Information Requests Based on Audio Data

FIG. 5 illustrates an example flowchart of a process 500 configured to generate information requests based on audio data, in accordance with one or more embodiments. Modifications, additions, or omissions may be made to the process 500. The process 500 may comprise more, fewer, or other operations than those shown in FIG. 5. For example, operations may be performed in parallel or in any suitable order. While at times discussed as the server 102, the user devices 106, or components of any of thereof performing operations described in operations 502-534 in the process 500, any suitable system or components of the system 100 may perform one or more operations of the process 500. For example, one or more operations of the process 500 may be implemented, at least in part, in the form of instructions 132 of FIG. 1, stored on non-transitory, tangible, machine-readable media (e.g., a non-transitory computer readable medium such as server memory 130 of FIG. 1) that when run by one or more processors (e.g., the server processor 126 of FIG. 1) may cause the one or more processors to perform operations described in operations 502-534.

The process 500 starts at operation 502, where the server 102 obtains audio data 140 from a user device 106a. In some embodiments, prior to obtaining the audio data 140 from the user device 106a, the server 102 may be configured to identify a communication exchange between the user device 106a and the workspace device 105a. In the communication exchange, the user device 106a may be authenticated by the workspace device 105a as being entitled to access one or more services 158. For example, the server 102 may be configured to identify conversations between the user device 106a and the workspace device 105a prior to evaluating any audio data 140. At operation 504, the server 102 is configured to execute the ML algorithm 172 to transcribe the audio data 140 into image data 142 and/or text data 144. The server 102 may be configured to transcribe multiple packets of audio data 140 over time. At operation 506, the server 102 is configured to generate a request summary (e.g., one of the summaries 136) based on the text data 144. The request summary may be representative of a predicted purpose associated with the audio data 140. For example, the server 102 may be configured to summarize the text data 144 down to one or two sentences to determine a current conversation purpose. There may be multiple conversation purposes over time. At operation 508, the server 102 is configured to retrieve previous request summaries 136 from previously determined reset points 166. At operation 510, the server 102 is configured to determine a target operation based on the request summary and the previous request summaries. The server 102 may be configured to determine a target operation 162 based on the request summary. The target operation 162 may be a determined intent to perform a specific communication operation 104.

At operation 520, the server 102 is configured to determine whether the rules and policies 150 at least partially match the target operation 162. The server 102 may be configured to determine whether the specific communication operation 104 at least partially matches the authorized communication operations 148. If the server 102 determines that the rules and policies 150 at least partially match the target operation 162 (e.g., YES), the process 300 proceeds to operation 532. In this regard, specific communication operations 104 are determined to at least partially match the authorized communication operations 148. At operation 532, the server 102 is configured to generate a report indicating that the target operation 162 is allowed. The report may be messaging and/or signaling configured to convey information. The process 500 may proceed to operation 534. If the server 102 determines that the rules and policies 150 do not at least partially match the target operation 162 (e.g., NO), the process 500 proceeds to operation 522. At operation 522, the server 102 is configured to generate a report indicating that the target operation 162 is not allowed. The summary request may be used to determine a possible intent for subsequent audio data 142. The process 500 may end at operation 522.

The process 500 may end at operation 534, where the server 102 may be configured to present the summary request as a new reset point 166 to train one or more ML models 176. Upon determining multiple new reset points 166, the server 102 may be configured to generate an overall communication summary. In response to generating the overall communication summary, the server 102 may be configured to execute the ML algorithm 172 to structure multiple datapoints representative of the overall communication summary to train the one or more ML models 176. In some embodiments, the server 102 may be configured to train the one or more ML models 176 in accordance with a structured version of the datapoints. The server 102 may be configured to delete and/or discard previous audio data collected if a new reset point 166 is generated.

### SCOPE OF THE DISCLOSURE

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. An apparatus, comprising:
a memory operable to store:
a machine learning algorithm configured to evaluate data in accordance with one or more machine learning models; and
a processor communicatively coupled to the memory and configured to:
obtain first audio data from a user device;
in response to receiving the first audio data, execute the machine learning algorithm to:
transcribe the first audio data into first text data;
summarize the first text data into a first request summary, the first request summary being representative of a first predicted purpose associated with the first audio data;
in response to summarizing the first text data, determine a first target operation based on the first request summary, the first target operation being a first determined intent to perform a first communication operation; and
map the first target operation to a first suggestion, the first suggestion comprising a first plurality action items to complete the first target operation; and
presenting the first suggestion to a workspace device.

2. The apparatus of claim 1, wherein:
the processor is further configured to:
prior to obtaining the first audio data from the user device, identify a communication exchange between the user device and the workspace device; and
in the communication exchange, the user device is authenticated by the workspace device as being entitled to access one or more services.

3. The apparatus of claim 1, wherein the processor is further configured to:
obtain second audio data and third audio data from the user device;
in response to receiving the second audio data and the third audio data, execute the machine learning algorithm to:
transcribe the second audio data into second text data;
transcribe the third audio data into third text data;
summarize the second text data and the third text data into a second request summary, the second request summary being representative of a second predicted purpose associated with the second audio data;
in response to summarizing the second text data and the third text data, determine a second target operation based on the second request summary, the second target operation being a second determined intent to perform a second communication operation; and
map the second target operation to a second suggestion, the second suggestion comprising a second plurality action items to complete the second target operation; and
present the second suggestion to the workspace device.

4. The apparatus of claim 1, wherein the processor is further configured to:
obtain second audio data and third audio data from the user device;
in response to receiving the second audio data and the third audio data, execute the machine learning algorithm to:
transcribe the second audio data into second text data;
summarize the second text data into a second request summary, the second request summary being representative of a second predicted purpose associated with the second audio data;
transcribe the third audio data into third text data;
summarize the third text data into a third request summary, the third request summary being representative of a third predicted purpose associated with the third audio data;
in response to summarizing the second text data and the third text data, determine a second target operation based on the second request summary and the third request summary, the second target operation being a second determined intent to perform a second communication operation; and
map the second target operation to a second suggestion, the second suggestion comprising a second plurality action items to complete the second target operation; and
present the second suggestion to the workspace device.

5. The apparatus of claim 1, wherein the processor is further configured to:
obtain second audio data from the user device;
in response to receiving the second audio data, execute the machine learning algorithm to:
transcribe the second audio data into second text data;
summarize the second text data into a second request summary, the second request summary being representative of a second predicted purpose associated with the second audio data;
in response to summarizing the second text data, determine a second target operation and a third target operation based on the second request summary, wherein:
the second target operation is a second determined intent to perform a second communication operation; and
the third target operation is a third determined intent to perform a third communication operation;
map the second target operation to a second suggestion, the second suggestion comprising a second plurality action items to complete the second target operation; and
map the third target operation to a third suggestion, the third suggestion comprising a third plurality action items to complete the third target operation; and
present the second suggestion and the third suggestion to the workspace device.

6. The apparatus of claim 5, wherein:
the first suggestion, the second suggestion, and the third suggestion are presented to the workspace device via a device interface;
in response to presenting the first suggestion to the workspace device, the workspace device is configured to perform a first update of a user interface (UI) in the device interface; and
in response to presenting the second suggestion and the third suggestion to the workspace device, the workspace device is configured to perform a second update of the UI in the device interface.

7. The apparatus of claim 6, wherein:
the second update comprises replacing the first suggestion with the second suggestion and the third suggestion in the UI.

8. The apparatus of claim 7, wherein the processor is further configured to:
generate an overall communication summary comprising a plurality of datapoints indicating of the first request summary in relation to a first plurality of words identified in the first text data, the second request summary in relation to a second plurality of words identified in the second text data, the first suggestion corresponding to the first target operation, the second suggestion corresponding to the second target operation, and the third suggestion corresponding to the second target operation;
in response to generating the overall communication summary, execute the machine learning algorithm to structure the plurality of datapoints to train the one or more machine learning models; and
train the one or more machine learning models in accordance with a structured version of the plurality of datapoints.

9. A method, comprising:
obtaining first audio data from a user device;
in response to receiving the first audio data, executing a machine learning algorithm to perform one or more operations comprising:
transcribing the first audio data into first text data;
summarizing the first text data into a first request summary, the first request summary being representative of a first predicted purpose associated with the first audio data;
in response to summarizing the first text data, determining a first target operation based on the first request summary, the first target operation being a first determined intent to perform a first communication operation; and
mapping the first target operation to a first suggestion, the first suggestion comprising a first plurality action items to complete the first target operation; and
present the first suggestion to a workspace device.

10. The method of claim 9, further comprising:
prior to obtaining the first audio data from the user device, identifying a communication exchange between the user device and the workspace device,
wherein, in the communication exchange, the user device is authenticated by the workspace device as being entitled to access one or more services.

11. The method of claim 9, further comprising:
obtaining second audio data and third audio data from the user device;
in response to receiving the second audio data and the third audio data, executing the machine learning algorithm to perform one or more additional operations comprising:
transcribing the second audio data into second text data;
transcribing the third audio data into third text data;
summarizing the second text data and the third text data into a second request summary, the second request summary being representative of a second predicted purpose associated with the second audio data;
in response to summarizing the second text data and the third text data, determining a second target operation based on the second request summary, the second target operation being a second determined intent to perform a second communication operation; and
mapping the second target operation to a second suggestion, the second suggestion comprising a second plurality action items to complete the second target operation; and
presenting the second suggestion to the workspace device.

12. The method of claim 9, further comprising:
obtaining second audio data and third audio data from the user device;
in response to receiving the second audio data and the third audio data, executing the machine learning algorithm to:
transcribing the second audio data into second text data;
summarizing the second text data into a second request summary, the second request summary being representative of a second predicted purpose associated with the second audio data;
transcribing the third audio data into third text data;
summarizing the third text data into a third request summary, the third request summary being representative of a third predicted purpose associated with the third audio data;
in response to summarizing the second text data and the third text data, determining a second target operation based on the second request summary and the third request summary, the second target operation being a second determined intent to perform a second communication operation; and
mapping the second target operation to a second suggestion, the second suggestion comprising a second plurality action items to complete the second target operation; and
presenting the second suggestion to the workspace device.

13. The method of claim 9, further comprising:
obtaining second audio data from the user device;
in response to receiving the second audio data, executing the machine learning algorithm to perform one or more operations comprising:
transcribing the second audio data into second text data;
summarizing the second text data into a second request summary, the second request summary being representative of a second predicted purpose associated with the second audio data;
in response to summarizing the second text data, determining a second target operation and a third target operation based on the second request summary, wherein:
the second target operation is a second determined intent to perform a second communication operation; and
the third target operation is a third determined intent to perform a third communication operation;
mapping the second target operation to a second suggestion, the second suggestion comprising a second plurality action items to complete the second target operation; and
mapping the third target operation to a third suggestion, the third suggestion comprising a third plurality action items to complete the third target operation; and
presenting the second suggestion and the third suggestion to the workspace device.

14. The method of claim 13, wherein:
the first suggestion, the second suggestion, and the third suggestion are presented to the workspace device via a device interface;
in response to presenting the first suggestion to the workspace device, the workspace device is configured to perform a first update of a user interface (UI) in the device interface; and
in response to presenting the second suggestion and the third suggestion to the workspace device, the workspace device is configured to perform a second update of the UI in the device interface.

15. The method of claim 14, wherein:
the second update comprises replacing the first suggestion with the second suggestion and the third suggestion in the UI.

16. The method of claim 15, further comprising:
generating an overall communication summary comprising a plurality of datapoints indicating of the first request summary in relation to a first plurality of words identified in the first text data, the second request summary in relation to a second plurality of words identified in the second text data, the first suggestion corresponding to the first target operation, the second suggestion corresponding to the second target operation, and the third suggestion corresponding to the second target operation;
in response to generating the overall communication summary, executing the machine learning algorithm to structure the plurality of datapoints to train one or more machine learning models; and
training the one or more machine learning models in accordance with a structured version of the plurality of datapoints.

17. A non-transitory computer-readable medium storing instructions that when executed by a processor cause the processor to:
obtain first audio data from a user device;
in response to receiving the first audio data, execute a machine learning algorithm to:
transcribe the first audio data into first text data;
summarize the first text data into a first request summary, the first request summary being representative of a first predicted purpose associated with the first audio data;
in response to summarizing the first text data, determine a first target operation based on the first request summary, the first target operation being a first determined intent to perform a first communication operation; and
map the first target operation to a first suggestion, the first suggestion comprising a first plurality action items to complete the first target operation; and
present the first suggestion to a workspace device.

18. The non-transitory computer-readable medium of claim 17, wherein:
the instructions further cause the processor to:
prior to obtaining the first audio data from the user device, identify a communication exchange between the user device and the workspace device; and
in the communication exchange, the user device is authenticated by the workspace device as being entitled to access one or more services.

19. The non-transitory computer-readable medium of claim 17, wherein the instructions further cause the processor to:
obtain second audio data and third audio data from the user device;
in response to receiving the second audio data and the third audio data, execute the machine learning algorithm to perform one or more additional operations comprising:
transcribe the second audio data into second text data;
transcribe the third audio data into third text data;
summarize the second text data and the third text data into a second request summary, the second request summary being representative of a second predicted purpose associated with the second audio data;
in response to summarizing the second text data and the third text data, determine a second target operation based on the second request summary, the second target operation being a second determined intent to perform a second communication operation; and
map the second target operation to a second suggestion, the second suggestion comprising a second plurality action items to complete the second target operation; and
present the second suggestion to the workspace device.

20. The non-transitory computer-readable medium of claim 17, wherein the instructions further cause the processor to:
obtain second audio data and third audio data from the user device;
in response to receiving the second audio data and the third audio data, execute the machine learning algorithm to:
transcribe the second audio data into second text data;
summarize the second text data into a second request summary, the second request summary being representative of a second predicted purpose associated with the second audio data;
transcribe the third audio data into third text data;
summarize the third text data into a third request summary, the third request summary being representative of a third predicted purpose associated with the third audio data;
in response to summarizing the second text data and the third text data, determine a second target operation based on the second request summary and the third request summary, the second target operation being a second determined intent to perform a second communication operation; and
map the second target operation to a second suggestion, the second suggestion comprising a second plurality action items to complete the second target operation; and
present the second suggestion to the workspace device.
